(19) United States
(12) Patent Application Publication
(10) Pub. No.: US 2004/0022698 A1
(43) Pub. Date: Feb. 5, 2004

(54) Apparatus for processing elemental sulfur-bearing materials to produce sulfuric acid and methods of using same

(76) Inventors: John L. Uhrie, Safford, AZ (US); Jeffrey A. Gurtler, Safford, AZ (US); Scott P. Hoenecke, West Olive, MI (US)

Correspondence Address: William F. Mulholland, II, Snell & Wilmer L.L.P., One Arizona Center, 400 East Van Buren, Phoenix, AZ, 85004-2202, US

(21) Appl. No.: 10/211,188

(22) Filed: Aug. 1, 2002

(51) Int. Cl. C01B 17/48; B01F 3/00

(52) U.S. Cl. 422/161; 422/160; 422/225; 422/224; 422/231

(57) ABSTRACT

A sulfuric acid production vessel is provided that oxidatively processes elemental sulfur or elemental sulfur-bearing materials to produce sulfuric acid. The vessel maximizes sulfuric acid production from elemental sulfur-bearing materials by enhancing solids retention of unreacted elemental sulfur by an associated settling device. The vessel may be operatively linked to one or more additional vessels in which the elemental sulfur-bearing material, or portions thereof are subjected to further processing, and thus further increase the yield of sulfuric acid produced.

### FIELD OF THE INVENTION

The present invention relates generally to methods and apparatus for manufacturing sulfuric acid, and more particularly, to methods and apparatus configured for manufacturing sulfuric acid from elemental sulfur-bearing materials using biological oxidation processes.

### BACKGROUND OF THE INVENTION

Sulfuric acid is used in a wide variety of commercial settings. For example, in connection with mining operations, sulfuric acid is used in “heap” or run-of-mine stockpile leaching of ore materials and recovery of desired metal values during solvent extraction.

The sulfuric acid supply for use in heap and run-of-mine stockpile leaching of copper, and other base metals and/or sulfide operations can be obtained from a variety of sources, for example, as follows:

(1) smelting, with the resulting gas stream processed in an acid plant to convert SO₂ to SO₃ and subsequent production of H₂SO₄ by absorption;

(2) roasting, with gas stream processed in an acid plant to convert SO₂ to SO₃ and subsequent production of H₂SO₄ by absorption;

(3) hydro-chemical oxidation of sulfide minerals to sulfuric acid directly in solution in a sulfur burner;

(4) combustion of elemental sulfur in a sulfur-burner to produce SO₃ and subsequent production of H₂SO₄ by absorption; and/or

(5) purchase from an off-site source.

However, there are significant costs associated with the production, purchase, transfer and transportation of acid that is generated by any of these processes. Some of these processes have the ability to generate electrical energy as a by-product, which can offset the costs of acid production. However, in addition to the cost, the amount of acid required for heap and stockpile leaching operations varies with time depending on the availability of heap and stockpile feed materials. In general, this demand has been increasing world-wide in recent years.

In addition, the permitting, regulatory and environmental requirements for these processes add cost and complexity, and the application of these technologies may, in some cases, be prohibitive.

While various biological oxidation devices are known, such devices have uniformly heretofore been used in connection with metal recovery processing.

Accordingly, an apparatus to produce low-cost sulfuric acid in an environmentally acceptable manner, such as through the use of biological oxidation processing, would be advantageous.

### SUMMARY OF THE INVENTION

The present invention addresses the shortcomings of the prior art by providing a convenient and cost effective apparatus for sulfuric acid production. While the way in which the present invention provides these advantages will be described in greater detail below, in general, a sulfuric acid production vessel is provided that oxidatively processes elemental sulfur or elemental sulfur-bearing materials to produce sulfuric acid. In at least some embodiments, the sulfuric acid production vessel maximizes sulfuric acid production from elemental sulfur-bearing materials by enhancing solids retention of unreacted elemental sulfur. The sulfuric acid production vessel may be operatively linked to one or more additional vessels in which the elemental sulfur-bearing material, or portions thereof (e.g., the unreacted solids) are subjected to further processing, and thus further increase the yield of sulfuric acid produced.

In accordance with an exemplary embodiment of the present invention, production of sulfuric acid from elemental sulfur generally includes the steps of: (i) providing to a production vessel a suitable elemental sulfur-bearing material; (ii) providing to a production vessel a suitable biological material capable of at least partially biooxidizing the elemental sulfur of the elemental sulfur-bearing material; (iii) subjecting the elemental sulfur of the elemental sulfur-bearing material to biological oxidation by the biological material within the production vessel; and (iv) recovering from the production vessel sulfuric acid from the biooxidized solution, while retaining in the production vessel at least a portion of any undigested elemental sulfur of the elemental sulfur-bearing materials.

In accordance with a further exemplary embodiment of the present invention, a sulfuric acid production vessel is provided wherein a solid/liquid separation device is associated with the production vessel. The solid/liquid separation device advantageously decouples the retention times for solids and liquids within the production vessel, wherein solids are retained in the production vessel longer resulting in a substantially more complete biological oxidation reaction. Accordingly, the resulting sulfuric acid product obtained is generally more highly concentrated and therefore useful in a variety of commercial settings. In accordance with another embodiment, a primary sulfuric acid production vessel is operatively linked to at least one further production vessel. In accordance with various aspects of this embodiment, unreacted sulfur solids contained in the eluted solution, that are not retained in the primary production vessel, are subjected to further processing in a secondary production vessel.

These and other advantages of the methods and apparatus according to various aspects of the present invention will be apparent to those skilled in the art upon reading and understanding the following detailed description with reference to the accompanying drawings.

### BRIEF DESCRIPTION OF THE DRAWINGS

The subject matter of the present invention is particularly pointed out and distinctly claimed in the concluding portion of this specification. A more complete understanding of the present invention, however, may be best obtained by referring to the detailed description and claims when considered in connection with the drawing figures, wherein like numerals denote like elements and wherein:

FIG. 1 illustrates a perspective view of an exemplary sulfuric acid production vessel in accordance with an embodiment of the present invention;

FIG. 1A illustrates an enlarged view of one portion of the vessel of FIG. 1;

FIG. 2 illustrates a schematic view of an exemplary tank biooxidation circuit in accordance with an embodiment of the present invention;

FIG. 3 illustrates a sectional view of an alternate embodiment of a sulfuric acid production vessel; and,

FIG. 4 illustrates a sectional view of a further alternate exemplary embodiment of a sulfuric acid production vessel in accordance with an embodiment of the present invention;

### DETAILED DESCRIPTION OF EXEMPLARY EMBODIMENTS OF THE INVENTION

In accordance with various aspects and embodiments of the present invention, an apparatus for producing sulfuric acid is provided. In general, a sulfuric acid production vessel is provided. The sulfuric acid production vessel may be suitably configured to receive various sulfuric acid production starting materials including elemental sulfur-bearing materials, biological materials, liquid media, and other materials. While the production vessel may receive any such materials, preferably, and in accordance with one embodiment of the present invention, the production vessel is suitably used for the biological oxidation of elemental sulfur-bearing materials. Specifically, the present invention addresses the need for a sulfuric acid source that can be conveniently and economically produced in proximity to mining operations. Of course, use of the apparatus of the present invention is not so limited, and thus may find use in any application where sulfuric acid is needed which is now known or hereafter devised by those so skilled in the art.

In the context of the present invention, the term “elemental sulfur-bearing material” refers to elemental sulfur, elemental sulfur together with other materials, or other elemental sulfur-bearing materials, such as other materials including some amount of elemental sulfur, such as some by-products of other metal recovery processes.

In accordance with another embodiment of the present invention, the term “elemental sulfur-bearing materials” also refers to other sulfur-bearing materials, such as acid generating sulfide sulfur-bearing materials including, for example, iron sulfides either alone or in conjunction with elemental sulfur or elemental sulfur-bearing materials.

In accordance with a further embodiment of the present invention, various combinations of elemental sulfur together with other materials may be provided. As a non-limiting example, such combinations may include elemental sulfur together with any other sulfides and/or other metals that might be attendant to or part of such elemental sulfur compositions.

In one exemplary embodiment, elemental sulfur-bearing material comprises an elemental sulfur-containing residue produced in connection with pressure leaching, particularly at low to medium temperatures (e.g. 85 to about 180° C.), of copper-containing material feed streams. As explained in greater detail in U.S. Ser. No. 09/915,105, such copper-containing materials include copper sulfide ores, such as, for example, ores and/or concentrates containing chalcopyrite (CuFeS₂) or mixtures of chalcopyrite with one or more of chalcocite (Cu₂S), bornite (Cu₅FeS₄), and covellite (CuS). The elemental sulfur-containing residues that result from the pressure leaching of such copper-containing material feed streams may advantageously be processed in accordance with the various aspects of the present invention.

In another exemplary embodiment, elemental sulfur-bearing material comprises acid generating sulfur bearing materials, such as iron sulfides or materials containing iron sulfides or other sulfide sulfur containing materials.

For purposes of this disclosure, in most instances, the term “elemental sulfur” is used interchangeably with the term “elemental sulfur-bearing material,” inasmuch as, as will be clear from the following disclosure, the elemental sulfur and sulfide sulfur components of any sulfur-bearing material are advantageously converted to sulfuric acid in accordance with the present invention.

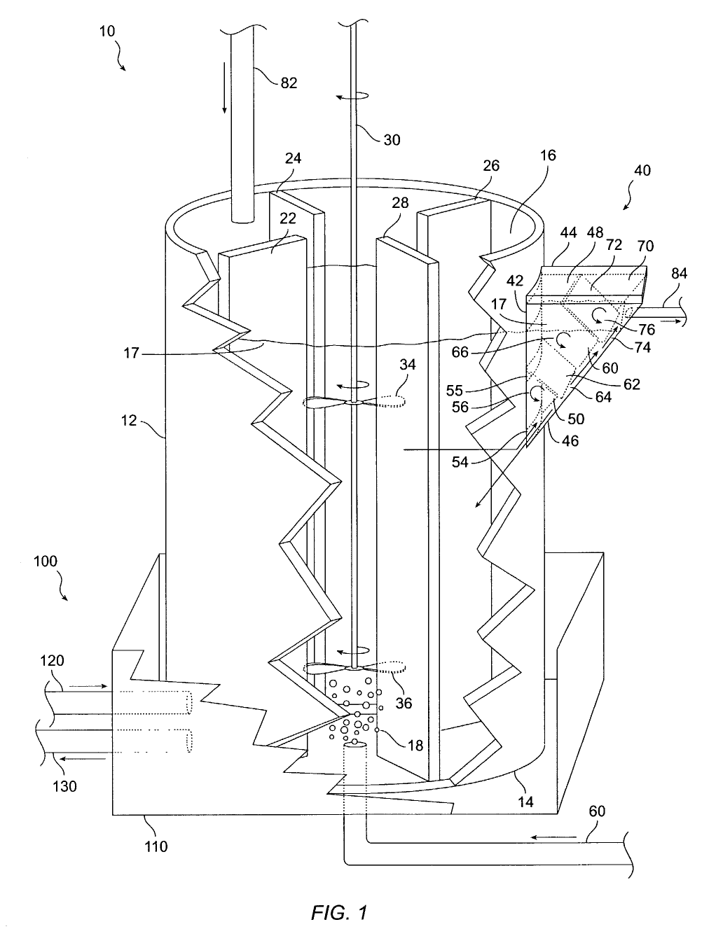

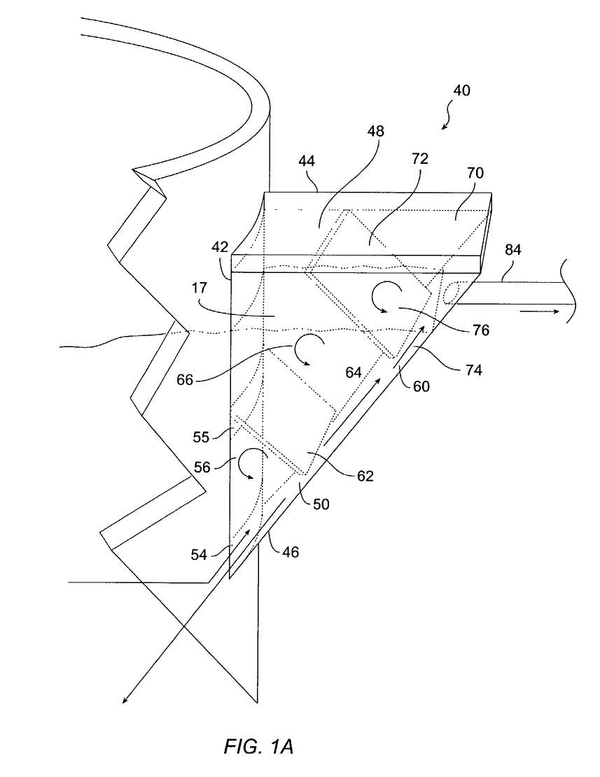

A production vessel for producing sulfuric acid 10 in accordance with various embodiments of the present invention is generally illustrated in FIG. 1. In general, as will be described in greater detail hereinbelow, production of sulfuric acid in production vessel 10 involves the formation of a suitable oxidation environment wherein sulfur-bearing materials are oxidized upon the addition of oxidizing materials. Preferably, the reaction materials are formed of biological materials wherein oxidation proceeds substantially via biological oxidation. In this regard, although generally beyond the scope of this application, reference is made to co-pending application U.S. Ser. No. ______, filed on ______, entitled “Method for the Biological Oxidation of Elemental Sulfur-Bearing Materials for Sulfuric Acid Production,” which discloses various suitable methods of producing sulfuric acid via biological oxidation. By this reference the subject matter of that application is hereby incorporated herein.

Preferably, and in accordance with various aspects of one embodiment of the present invention, the elemental sulfur-bearing materials are suitably provided in an aqueous solution. The aqueous solution may comprise any material capable of supporting appropriate reaction conditions for biological oxidation (“biooxidation”) of the elemental sulfur-bearing materials. Preferably, the aqueous solution comprises water, raffinate (that is the residual solution following copper extraction in a solution extraction system) or mixtures thereof. However, any suitable fluid medium may be used.

Conversion of elemental sulfur-bearing materials to sulfuric acid in accordance with the present invention is facilitated by the addition of biological materials, for example, biooxidizing bacteria. As those skilled in the art will understand, the oxidation of elemental sulfur and resulting production of sulfuric acid is represented by the following reaction:

(elemental sulfur) 2S^{O}+3O₂+2H₂O→2H₂SO₄ (1)

Similarly, sulfur-bearing materials, such as pyrite, are converted to sulfuric acid as follows:

(pyrite) 2FeS₂+7O₂+2H₂O→2FeSO₄+2H₂SO₄ (2)

In accordance with the present invention, utilization of biooxidizing bacteria enhances the oxidation rate of the sulfur-bearing materials thereby enhancing the yield and/or rate of sulfuric acid production. These advantages, in accordance with other features of the present invention, provide a method for producing sulfuric acid on a commercial scale at economically acceptable rates.

In accordance with various embodiments of the present invention, any bacteria that serve to facilitate such conversion reactions may be used. The following bacteria are exemplary:

Group A: Acidithiobacillus ferrooxidans; Acidithiobacillus thiooxidans; Acidithiobacillus organoparus; Acidithiobacillus acidophilus; Acidithiobacillus caldus

Group B: Sulfobacillus thermosulfidooxidans; Sulfolobus sp.

Group C: Sulfolobus acidocaldarius; Sulfolobus BC; Sulfolobus solfataricus; Metallosphaera sedula; Acidianus brierleyi and the like.

These bacteria are generally available, for example, from American Type Culture Collection, or like culture collections, or are known in the art.

In accordance with a preferred aspect of the present invention, Acidithiobacillus caldus bacteria are utilized under operating conditions at or about 40° C. However, as noted above, any biological material including microbial agents, other microorganisms, bacteria, and the like, which are capable of at least partially oxidizing elemental sulfur-bearing materials, may be used in accordance with the methods herein described. Appropriate biomass production may be practiced by techniques commonly known in the art, such as disclosed in “Biology of Microorganisms,” Madigan and Marttinko, Ninth Ed., Prentice-Hall (2000).

Additional materials to facilitate, aid, or enhance the oxidizing of elemental sulfur-bearing materials may also be employed in accordance with various aspects of the present invention. For example, the addition of nutrients may be beneficial in many applications. Though biooxidizing biological materials, including bacteria, derive energy, in part, from the oxidation of sulfur, additional nutrient materials may aid in cell growth and oxidation functions in accordance with the present invention.

Nutrients, including ammonia, phosphate, potassium, and magnesium may be added to facilitate oxidation processes and aid cell growth and maintenance. For example, these nutrient constituents may be introduced in any suitable media, including a Modified Kelly's Media (MKM), in the following concentrations comprising:

| | |
|---|---|
| (NH₄)₂SO₄ | (0.4 gpl) |
| K₂HPO₄ | (0.04 gpl) |
| MgSO₄ 7H₂O | (0.4 gpl) |

However, other nutrient constituents and concentrations may be used, depending on the precise requirements and conditions of the desired system. For example, the nutrient constituents of ambient air, such as carbon dioxide, may also be used to enrich the reaction media. Other forms of enriched air may also be used in accordance with the present invention, including, for example, enriched oxygen air. However, enrichment of the reaction media may proceed by any other suitable method, now known or developed in the future.

Other materials including various solvents, reaction aids, wetting agents, and others may also be advantageously employed in accordance with various aspects of certain embodiments of the present invention.

In an exemplary embodiment, a sulfuric acid production vessel 10 is provided, as generally illustrated in FIG. 1, and comprises a generally cylindrical wall 12 disposed overlying a circular floor section 14 and further comprises an opening 16. A fluid inlet 82 may be positioned to extend through the opening 16 for delivering elemental sulfur-bearing materials, biological materials, liquid media, and other suitable materials to form an aqueous media 17 contained within production vessel 10. In a preferred embodiment, elemental sulfur is provided in a powdered form and delivered by a separate screw-type conveyor apparatus (not shown).

The aqueous media 17 may be subjected to aeration in order to enhance growth of biological materials and enhance the biological oxidization conversion of elemental sulfur of the elemental sulfur-bearing materials to sulfuric acid. In accordance with one embodiment, an air inlet 18 is disposed in association with production vessel 10. Ambient air and/or enriched air is suitably delivered via inlet 18 to production vessel 10. Such air may be introduced into the aqueous media 17 by any suitable air production device (not shown) including a blower device or compressor device. Preferably, air produced from a production device is directed into a delivery line 60 operatively connected to air inlet 18. Preferably, air is delivered beneath the surface of aqueous media 17, and more preferably, air inlet 18 is positioned in proximity to production vessel floor 14 to maximize dispersion of ambient air into the bulk solution of the aqueous media 17. However, any suitable device or process for aeration may be used.

In accordance with another aspect of this embodiment of the present invention, aeration may be facilitated by increasing the surface area of air bubbles introduced into aqueous media 17. In general, any device suitable to increase the surface area of the air bubbles may be used. In accordance with one aspect of this embodiment of the present number, a first impeller 36 is provided, as is illustrated in FIG. 1. First impeller 36 may be connected to shaft 30 and disposed within production vessel 10. Preferably, first impeller 36 is positioned in proximity to air inlet 18. As such, at least a portion of air delivered into the aqueous medium 17 may be subjected to shearing and/or mixing by impeller 36. More preferably, impeller 36 is suitably placed in close association with air inlet 18 in order to maximize shearing and/or dispersion of the air bubbles upon delivery.

In accordance with a further aspect of this embodiment, an air diffuser (not shown) may be positioned in association with air inlet 18 in order to promote dispersion and increase the surface area. Any suitable diffuser device may be used with this aspect of the present invention, including porous rock, grated mesh or similar devices to promote finer dispersion of the air bubbles into the aqueous media 17. Such diffuser devices may or may not be used in conjunction with shearing impeller 36.

In accordance with a still further aspect of this embodiment of the present invention, aeration may be facilitated by mechanical agitation or moving of aqueous media 17. In general, any suitable device may be used for this purpose. For example, first impeller 36 alone may provide suitable agitation of the aqueous media 17. While a single impeller may be configured to promote both dispersion of the air bubbles and mixing of the aqueous media 17, in accordance with one embodiment of the present invention, more than one impeller is suitably used to facilitate dispersion and mixing. For example, in accordance with one aspect of this embodiment of the present invention a first impeller is configured primarily for dispersion of the air bubbles and a second impeller is configured primarily for mixing of the aqueous media 17. For example, as further illustrated in FIG. 1, a second impeller 34, similarly connected to shaft 30, is disposed within the production vessel 10. Second impeller 34 may be positioned at any suitable point along shaft 30 to promote suitable mixing. Preferably, as illustrated best in FIG. 1, second impeller 34 is positioned in proximity to the upper surface of aqueous media 17.

In accordance with another embodiment of the present invention, production vessel 10 is suitably configured to promote re-wetting of the elemental sulfur. As those skilled in the art will appreciate, elemental sulfur is hydrophobic, and thus may tend to collect on the surface of aqueous media 17. In accordance with one aspect of this embodiment of the present invention, production vessel 10 is suitably configured to promote agitation about the surface of the aqueous media 17. Such agitation (e.g., mixing) may be suitably facilitated by effective positioning of second impeller 34, for example, such as in cases where second impeller 34 is suitably positioned in close relationship with the surface of the aqueous media 17, in order to facilitate wetting the sulfur content through the agitation and/or churning of the surface layer.

However, any device configured to suitably agitate the bulk aqueous media 17 and/or the surface of the aqueous media 17 or otherwise facilitate wetting and/or re-wetting of the elemental sulfur may be used. Further, to the extent impellers are used in accordance with the present invention, such impellers may be configured in either an up-pumping or down-pumping configurations as will be described in greater detail hereinbelow.

In accordance with a further aspect of the present invention, agitation of the aqueous media 17 is facilitated by the substantial prevention of vortexing. In accordance with one aspect of this embodiment of the present invention, one or more mixing baffles may be disposed within production vessel 10. In an exemplary embodiment, as shown in FIG. 1, four respective mixing baffles, 22, 24, 26 and 28, are positioned longitudinally, preferably in an equidistant relationship about interior cylindrical wall 12 of vessel 10. Mixing baffles 22, 24, 26, and 28 may be configured in any suitable length and width. Preferably, mixing baffles 22, 24, 26, and 28 extend from floor 14 of production vessel 10, through aqueous media 17, and suitably terminate above the surface of aqueous media 17, such as is also shown in FIG. 1.

However, in accordance with some aspects of this embodiment, vortexing on the surface of the aqueous may be preferable and serve to effectively minimize surface collection of sulfur. For example, where the mixing baffles are configured to terminate below the surface of aqueous media 17 (not shown), surface vortexing may be advantageously facilitated. This configuration may be preferable in certain applications, for example in connection with certain down-pumping configurations that will be described in greater detail hereinbelow. In certain applications, such surface agitation may in turn facilitate advantageous re-wetting of the elemental sulfur, that is the elemental sulfur which otherwise may tend to collect on the surface of aqueous media 17 as a froth. However, any suitable device to prevent vortexing may be used in accordance with this embodiment of the present invention.

Production vessel 10 may be formed of any suitable material to accommodate the various components of the aqueous media 17. In accordance with various aspects of the present invention, anti-corrosive materials, such as stainless steel or the like are preferred. More preferably, plastic or fiberglass materials may be used. Still more preferably, production vessel 10 may comprise high-density polyethylene (HDPE). Alternatively, in another preferred embodiment, production vessel 10 may be formed of a steel material associated with an inner lining formed of a rubber-based material. However, any material that minimizes the corrosive effects of the sulfuric acid produced may be used. Additionally, baffles 22, 24, 16, and 28, impellers 34 and 36, shaft 30, as well as the other components of production vessel 10 may also be comprised of non-corrosive materials, though not necessarily the same or similar type of materials contained in the production vessel.

In accordance with one embodiment of the present invention, sulfuric acid production vessel 10 is suitably configured to promote solids retention as the resulting sulfuric acid is suitably eluted from the tank. In general, any suitable solid/liquid separation device may be used. In a preferred exemplary embodiment and with reference again to FIG. 1 and in particular FIG. 1A, a settling device 40 is associated with the production vessel 10. In general, settling device 40 is suitably configured to facilitate effective elution from vessel 10 of sulfuric acid produced in the biological oxidation reactions carried out therein, as well as retention of the undissolved and/or unreacted (e.g. undigested) solid materials. In this manner, further biological oxidation of the unreacted materials may be effectuated, while resultant sulfuric acid is advantageously removed from vessel 10. In general, setting device 40 includes one or more settling zones configured to promote settling of solids from suspension in the aqueous medium. The settling zones may be configured in any suitable manner, but in general comprise a chamber formed of at least one angular wall configured to promote reintroduction of settled solids back into production vessel 10.

In accordance with one aspect of this embodiment of the present invention, effluent (e.g., sulfuric acid) travels through settling device 40 and is discharged through an effluent tube 84. Preferably, settling device 40 comprises a first wall 42 and a second wall 44 arranged in a parallel relationship, such as in a right triangle formation, such that a first leg extends longitudinally along the outer sidewall of production vessel 10 and a second leg of extends outwardly in a horizontal fashion there from. A third leg, or hypotenuse, of the triangle is positioned in an upwardly inclined fashion connecting the first and second legs. A third wall 46 may be positioned in a similar upwardly inclined fashion between first and second walls 42 and 44, thereby forming a cavity 48 disposed therein.

In such a configuration and with continued reference to FIG. 1A, a series of settling zones are disposed within cavity 48, for example, a first settling zone 50, a second settling zone 60, and a third settling zone 70. Advantageously, first settling zone 50 is positioned in a substantially intersecting relationship with sidewall 12 of production vessel 10 such that liquid and solid materials may enter and exit settling device 40 through respective openings 54 and 55. A first chamber separator 62 suitably bisects first settling zone 50 and second settling zone 60. An opening 64 advantageously positioned at the base of first chamber separator 62 can permit further delivery of liquids and solids into and out of second settling zone 60. A second chamber separator 72 suitably bisects second settling zone 60 and third settling zone 70. An opening 74 advantageously positioned at the base of second chamber separator 72 can permit even further delivery of liquids and solids into and out of third settling zone 70. In this illustrated configuration an effluent tube 84 is suitably positioned in association with third settling zone 70 to permit delivery of liquids and solids materials out of processing vessel 10.

On the other hand, effluent containing undigested sulfur solids is suitably retained within production vessel 10 with this illustrated configuration of settler 40. For example, undigested elemental sulfur, that is solid residue, is caused to enter first settling zone 50 through opening 54. First settling zone 50 preferably comprises a first turbulent zone 56. As such, within first settling zone 50, solids will tend to settle out of suspension, and they can be advantageously reintroduced into production vessel 10 through the unique design of the settler. More generally, as solids settle out of suspension, they tend to slide down sloping third wall 46 of settler 40 back into the production vessel through opening 54.

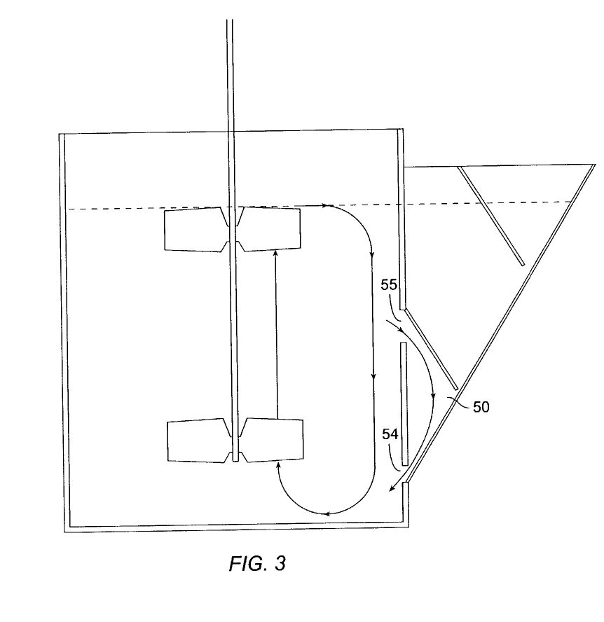

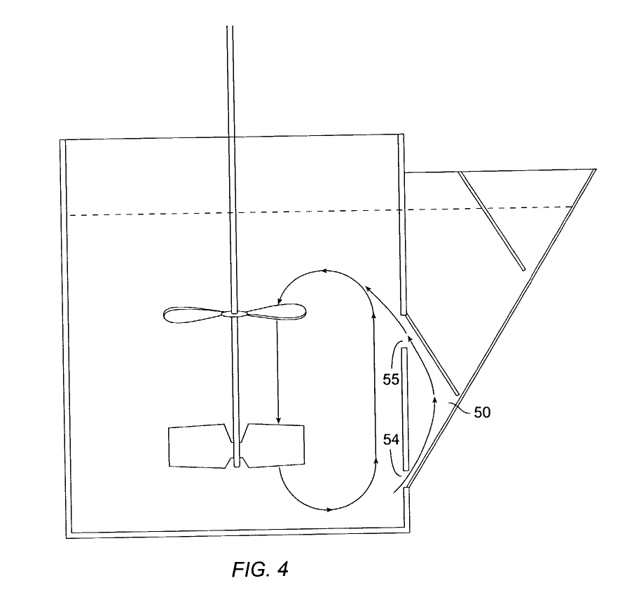

In an alternative aspect of this embodiment of the present invention an additional opening 55 is advantageously positioned in sidewall 12, such that first settling zone 50 contains a first and second opening through which the aqueous medium may enter and exit, depending upon the fluid dynamics of the system. For example, with momentary reference to FIG. 3, in an up-pumping system, fluid tends to enter settling zone 50 through opening 55 and exit through opening 54. Conversely, and with momentary reference now to FIG. 4, in a down-pumping configuration, fluid tends to enter settling zone 50 through opening 54 and exit through opening 55. In either case, opening 55 suitably prevents such build-up of air within the chamber by providing appropriate settling and effluent removal, as well as appropriate air control. In a preferred aspect of this embodiment of the present invention, the width of the intake opening is positioned larger in relation to the width of exit opening. However, any configuration tending to promote suitable solids retention and effluent removal may be employed.

With continued reference to FIG. 1, in exemplary operation, effluent travels from settling zone 50, into second settling zone 60 through opening 64. Second settling zone 60 preferably comprises a second turbulent zone 66. However, preferably second turbulent zone generally has reduced turbulence and increased laminar flow relative to first turbulent zone 56. Within second settling zone 60, additional solids further settle from suspension and tend to settle at the bottom of downward sloping wall 46. The collected solids are caused to then travel down sloping third wall 46 through opening 64, preferably positioned approximately at the bottom of first chamber separator 62, into first settling zone 50 and then back into the production vessel 10, such as through opening 54 or opening 55.

In similar fashion, the effluent solution is suitably caused to enter the effluent discharge zone 70 through opening 74. Effluent discharge zone 70 comprises a third turbulent zone 76. However, turbulent zone 76 is preferably substantially non-turbulent, or laminar, as compared to respective first and second turbulent zones 56 and 66. Within effluent discharge zone 70, further solids are settled from suspension for reintroduction into production vessel 10. For example, the discharged solids are caused to slide down sloping third wall 46, into second settling zone 60 through second chamber separator 72 at opening 74, then into first settling zone 50 through first chamber separator 62 at opening 64, and ultimately back into production vessel 10 through opening 54 or opening 55. The resultant effluent can then be discharged out of production vessel 10 through effluent line 84 for additional processing, storage, and/or introduction into a process stream.

It should be appreciated that the illustrated and now described settling device 40 suitably promotes solid/liquid separation of the sulfuric acid from the undigested (e.g. un-biooxidized) elemental sulfur and the like. Stated another way, settling device 40 decouples the retention time for solids and liquids within the production vessel wherein solids are typically retained for a longer period of time relative to liquids. The increased retention time for solids enhances conversion of sulfur-bearing materials to sulfuric acid. However, those skilled in the art will appreciate that a greater or lesser number of settling zones may be used in accordance with various aspects of the present invention. Additionally, the size openings in the chamber separator walls may be adjusted to affect turbulent reduction and/or laminar increase in each of the respective settling zones. Further, additional configurations which also tend to promote solid/liquid separation, that is increased retention of undigested elemental sulfur within production vessel 10 and discharge of the sulfuric acid product, may be utilized in accordance with various additional embodiments or aspects of the present invention.

In accordance with certain aspects of the present invention in some cases, it may be desirable to maintain liquid media within a preselected temperature range. For this purpose, any suitable temperature maintenance device may be used. In an exemplary embodiment, a heat exchange device 100 is suitably positioned in association with production vessel 10, such as is illustrated in FIG. 1. Preferably, heat exchange device 100 comprises a cooling/heating jacket 110 positioned in association with production vessel 10. Jacket 110 preferably includes an inlet 120 and an outlet 130. Depending upon the desired specific reaction conditions and bacteria selected, the temperature of aqueous media 17 is preferably maintained in a range of about 35° C. to about 60° C., and more preferably on the order of about 40° C. Accordingly, heat exchange device 100 comprising jacket 110 is configured to maintain the temperature of aqueous media 17 within production vessel 10 in a desirable temperature range. In one exemplary aspect of this embodiment of the present invention, an aqueous solution, and preferably a cooled solution relative to the temperature of aqueous media 17, is delivered into jacket 110 through inlet 120. The influencing affect on the temperature of the reaction solution may be based, in part, upon the temperature of the aqueous solution circulated into the cooling jacket and the rate of circulation to and from the jacket, among others. As the cooled solution circulates throughout jacket 110, heat from the production vessel is preferably transferred into the cooled aqueous solution contained within jacket 110, in a conventional manner. The warmed solution then may be discharged out of jacket 110 through outlet 130 and subject to further cooling.

However, any suitable heat maintenance device now known or hereafter devised may be used to suitably maintain the temperature of vessel 10, and this aqueous media 17. For example, any arrangement that situates the reaction chamber in association with conductive elements tending to conduct heat away from the reaction chambers may be used.

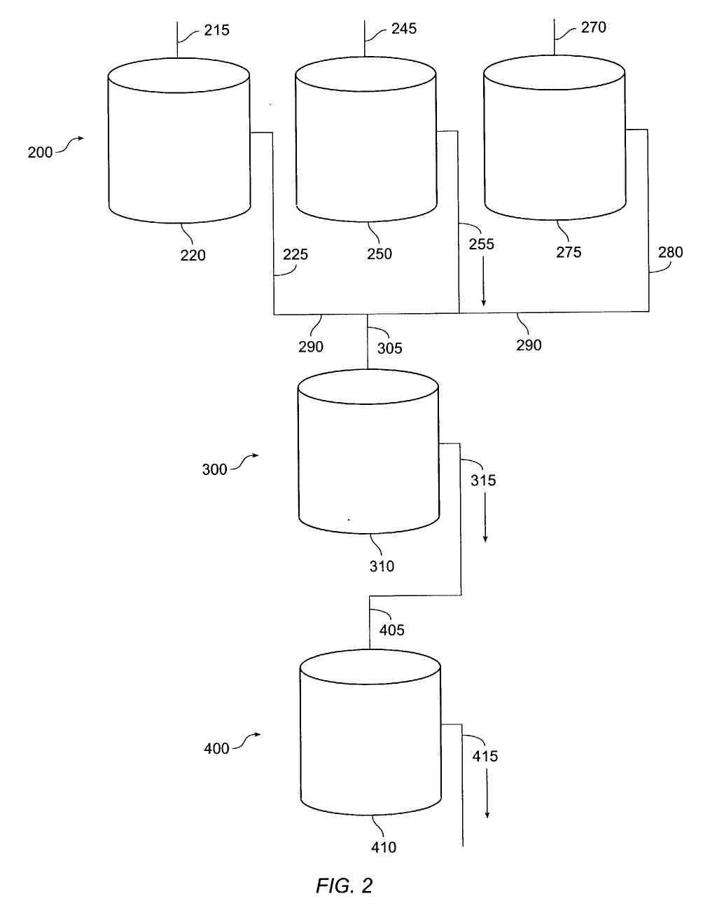

In accordance with a further embodiment of the present invention, production vessel 10 may be operatively linked with at least one additional production vessel to facilitate further processing of undigested elemental sulfur solids, preferably undigested elemental sulfur solids which are contained within the effluent sulfuric acid solution. In one exemplary aspect of this embodiment of the present invention, a plurality of production vessels are provided in a circuit configured to advantageously facilitate further oxidation of the elemental sulfur. For example, and with reference now to FIG. 2, a production circuit 150 suitably may be arranged in three production stages; namely, a primary stage 200, a secondary stage, 300, and a tertiary stage 400.

In the exemplary embodiment illustrated in FIG. 2, primary stage 200 preferably comprises three primary production vessels 220, 250, and 275. Primary production vessel 220 comprises influent line 215 and an effluent line 225. Similarly, primary production vessels 250 and 275 preferably comprise respective influent lines 245 and 270 and respective effluent lines 255 and 280 respectively. Each effluent line 225, 255, and 280 are further advantageously operatively connected to a common effluent line 290.

Influent is suitably introduced into the circuit through influent lines 215, 245, and 270. Preferably, each of vessel 220, 250 and 275 are suitably configured for receipt of sufficient elemental sulfur-bearing material, biological material, oxygen and other additives to facilitate, as described in greater detail hereinabove, for example in connection with vessel 10, the biological oxidation of the elemental sulfur-bearing material to produce effluent sulfuric acid. That is, at least part of the aqueous media 17 is discharged from primary production vessels 220, 250, and 275 as additional reaction materials are delivered into the vessels. The discharged effluent enters effluent lines 225, 255, and 280 respectively for delivery into secondary stage 300, via common effluent line 290.

Secondary stage 300 preferably comprises a secondary production vessel 310. As with vessels 220, 250, and 275, vessel 310 is suitably configured to subject effluent from primary stage 200 to further biological oxidation. That is, effluent leaving primary production stage 200 suitably enters secondary reaction vessel 310 through an influent line 305. Influent entering the secondary vessel preferably causes an appropriate amount of aqueous media 17 containing produced sulfuric acid to be discharged into effluent line 315 for delivery into tertiary stage 400.

Tertiary stage 400 comprises a tertiary production vessel 410, also configured to facilitate further biological oxidation. Effluent leaving secondary production stage 300 enters tertiary reaction vessel 410 through an influent line 405. Influent entering tertiary vessel 410 preferably causes an appropriate amount of aqueous media 17 to be discharged into effluent line 415 for delivery into storage and/or further processing.

As will be understood by the skilled artisan, such circuit processing enables further biological oxidation and recovery of the produced sulfuric acid. Other circuit configurations can be employed, as may other arrangements or combinations of stages. Moreover, the circuit may be configured as an overflow system (not shown) wherein a given amount of influent displaces a similar amount of aqueous media 17 as effluent which is caused to overflow out of the respective reactor vessels for delivery into a downstream stage using, for example, gravity-fed lines. However, any liquid delivery system may be used in accordance with the present invention.

In accordance with this aspect of the present invention, more highly concentrated sulfuric acid may be recovered in less time and at a lower cost than processing in a simple vessel. As such, each successive stage may be utilized to obtain a more highly concentrated product as the various stages of biooxidation proceed in accordance with the various embodiments of the present invention. However, as will be further understood by skilled artisans, in accordance with various other embodiments of the present invention, effluent from a single production vessel may also be recirculated back into the production vessel for further processing to obtain a more highly concentrated product as well.

The present invention has been described above with reference to a number of exemplary embodiments. It should be appreciated that the particular embodiments shown and described herein are illustrative of the invention only. Those skilled in the art having read this disclosure will recognize that changes and modifications may be made to the exemplary embodiments without departing from the scope of the present invention. For example, although reference has been made throughout to sulfuric acid production in a production vessel, it is intended that the invention also be applicable to any suitable configuration capable of containing an aqueous medium during biooxidation such as in-ground containment vessels, ponds, and the like. Further, although certain preferred aspects of the invention, such as techniques and apparatus for shearing and/or mixing the aqueous solution, and arrangements of production vessels in a circuit, for example, are described herein in terms of exemplary embodiments, such aspects of the invention may be achieved through any number of suitable devices now known or hereafter devised. Additionally, the solid/liquid separation device has been described as attached to the production vessel for illustration purposes only. Any device that promotes solid/liquid separation and/or retention of unreacted sulfur solids, whether or not attached to the production vessel, such as, for example, positioned in a down stream relationship from the production vessel, may be used in accordance with the present invention. Additionally, this invention has been described in terms of sulfuric acid production for illustration purposes only. However, the scope of this invention is not so limited and may be used for any application requiring oxidative processes, such as sulfide mineral oxidation, or dissolution of solids materials in general. Accordingly, these and other changes or modifications are intended to be included within the scope of the present invention, as expressed in the following claims.

1. An apparatus for the production of sulfuric acid from elemental sulfur-bearing materials comprising:
a production vessel configured to receive a reaction solution comprising elemental sulfur-bearing materials, biological materials, liquid media, oxygen and other materials to facilitate the biological oxidation of said elemental sulfur-bearing material to form sulfuric acid; and
an outlet associated with said reaction vessel, said outlet configured to enhance retention of at least some undigested elemental sulfur from said elemental sulfur-bearing material while permitting discharge of at least some of said sulfuric acid produced from said production vessel thereby promoting a more complete biological oxidation of elemental sulfur and facilitating greater sulfuric acid production.

2. The apparatus of claim 1 wherein said outlet comprises a solid/liquid separation device including at least one settling zone configured to partially settle at least some solids from the reaction solution.

3. The apparatus of claim 2 wherein said settling zone is configured to receive at least partially turbulent reaction solution from said production vessel and wherein the reaction solution is at least partially laminar within said settling zone relative to the reaction solution within said production vessel.

4. The apparatus of claim 2 wherein said solid/liquid separation devise comprises two or more settling zones, wherein each successive settling zone is arranged in a downstream relationship and wherein the reaction solution within each downstream settling zone is at least partially more laminar in relation to the reaction solution in upstream settling zones.

5. The apparatus of claim 2 wherein said solid/liquid separation device is further configured to return said sulfur solids settled from solution back into said production vessel.

6. An apparatus for the production of sulfuric acid comprising:
a production vessel;
an inlet;
a settling device; and,
a production region within said production vessel; and
wherein said inlet is connected to said production vessel to provide to said production region a reaction media comprising elemental sulfur-bearing materials, biological materials and other materials to subject the elemental sulfur-bearing materials to biological oxidation to produce sulfuric acid and a residue of undigested elemental sulfur; and
wherein said settling device is operatively linked to said production vessel and wherein said settling device is configured to at least partially decouple the retention times for elemental sulfur solids and liquids within the production vessel, wherein said solids are retained within said production vessel for a longer period of time thereby facilitating a more complete biological oxidation reaction and facilitating greater sulfuric acid production.

7. The apparatus of claim 6 wherein said settling device further comprises a first settling zone configured to partially settle at least some solids from the reaction media and wherein said first settling zone comprises at least one opening in an intersecting relationship with said production vessel through which reaction media may enter and exit and through which sulfur solids may reenter said production vessel.

8. The apparatus of claim 7 wherein said settling device further comprises a second settling zone positioned in a downstream relationship from said first settling zone, and wherein a separator is disposed between said first and said second settling zones and wherein said separator is configured with at least one opening to permit delivery of liquids and solids into and out of the second settling zone.

9. An apparatus for use in the production of sulfuric acid from elemental sulfur-bearing materials comprising:
a production vessel having an inlet and an outlet, said inlet being suitably configured for delivery of elemental sulfur-bearing materials, biological materials, liquid media and other materials to form an aqueous reaction solution;
an aeration device operatively connected to said production vessel configured to promote the introduction of a gas into said production reaction solution; and
an outlet configured to retain at least some sulfur solids within said production vessel and further configured to permit discharge of at least some sulfuric acid produced within said reaction solution.

10. The apparatus of claim 9 further comprising:
an agitation device arranged within said production vessel and configured for agitation of said reaction solution therein.

11. The apparatus of claim 9 wherein said aeration device comprises an air inlet device.

12. The apparatus of claim 9 wherein said aeration device comprises an impeller.

13. The apparatus of claim 9 wherein said aeration device comprises an air inlet device and a first impeller and said first impeller is configured to maximize the dispersion of gas.

14. The apparatus of claim 10 wherein said agitation device comprises an impeller configured to promote mixing of said reaction solution.

15. The apparatus of claim 10 wherein said agitation device comprises at least one baffle.
